(19) United States
(12) Patent Application Publication
(10) Pub. No.: US 2024/0202842 A1
(43) Pub. Date: Jun. 20, 2024

(54) U-fora.com

(71) Applicant: Michael Allen, Baltimore, MD (US)

(72) Inventor: Michael Allen, Baltimore, MD (US)

(21) Appl. No.: 18/593,862

(22) Filed: Mar. 2, 2024

(51) Int. Cl. G06Q 50/00

(52) U.S. Cl. CPC G06Q 50/01

(57) ABSTRACT

Introducing a multifaceted social network that seamlessly integrates podcast and radio features, supports crowdfunding initiatives, and facilitates the sharing of music and ebooks. Users can immerse themselves in a diverse world of audio content, contribute their creations, and engage in crowdfunding campaigns—all within a single, interconnected platform. The inclusion of offline access through downloads adds flexibility, while a unified interface simplifies connectivity to other social networks, making it a central hub for both creation and collaboration in the digital realm. This abstract captures a dynamic ecosystem that fosters creativity, community support, and seamless interaction across various media formats.

### 1. SUMMARY OF INVENTION

U-fora.com is a social network platform that is distributed as an app and website. U-fora.com integrates radio stations, podcasts, and crowdfunding. U-fora.com allows its users to listen to, create, and follow radio stations or podcasts while also initiating crowdfunding campaigns within the platform. It's a versatile space for content creation and support through community-driven funding.

### 2. DETAILED DESCRIPTION OF INVENTION

U-fora.com is a social network that seamlessly integrates podcast and radio station features, enabling users to discover, follow, and listen to podcast and radio stations as well as create their own podcast, radio stations and crowdfunding campaigns. Additionally, the platform empowers users to initiate this content directly within the network, fostering community support for various creative projects, causes, or ventures. This convergence of audio content and crowdfunding creates a multifaceted social experience, where users can engage with both curated media and collaborative initiatives within a single, interconnected space.

This innovative social network not only offers podcast and radio station features but also allows users to upload and share their music, ebooks and audio books for other users and the public to download. Users can contribute to a diverse library of audio and literary content, creating a rich, collaborative environment. Moreover, the platform supports downloads, enabling users to access their favorite music tracks and ebooks offline. With this holistic approach, the social network becomes a one-stop destination for audio content, literature, and crowdfunding initiatives, fostering a vibrant and supportive community of creators and consumers.

U-fora.com has a user-friendly menu that features direct links to various popular social networks. This menu serves as a gateway, offering users easy access to popular and high ranked social network platforms more. By incorporating these links, the social network enhances connectivity, allowing users to effortlessly navigate between different platforms and share their favorite content, crowdfunding campaigns, and experiences seamlessly across the broader social media landscape.

### 3. FEATURES OF U-FORA.COM

### 4. PODCAST AND RADIO INTEGRATION

Users can discover, listen to, create and follow their favorite podcasts and radio stations within the social network.
The platform offers a curated space for audio content, enhancing the overall user experience.

### 5. CROWDFUNDING CAMPAIGNS

Users have the ability to initiate crowdfunding campaigns directly on the social network.

This feature empowers creators to seek financial support for various projects, causes, or ventures from the community.

### 6. MUSIC AND EBOOK UPLOADS

Users can upload and share their music and ebook creations on the platform.

This expands the content library, providing a diverse range of user-generated audio and literary material.

### 7. DOWNLOADS FOR OFFLINE ACCESS

The platform supports downloads, allowing users to access their favorite music tracks and ebooks offline.

This feature enhances flexibility, enabling users to enjoy content without the need for a constant internet connection.

### 8. UNIFIED INTERFACE (MUNI)

The social network incorporates a unified interface (Muni) for seamless access to other social network apps.

Users can manage and integrate their interactions across platforms, streamlining their digital presence.

### 9. MENU WITH SOCIAL NETWORK LINKS

The user-friendly menu includes direct links to popular social networks such as Facebook, Twitter, and Instagram.

This menu enhances connectivity, facilitating easy navigation between platforms and encouraging users to share content and experiences across a broader digital landscape.

2. Inventor claims that u-fora.com is the first social network that offers users the ability to discover, follow, listen to podcast and radio stations as well as create their own podcast, radio stations and crowdfunding campaigns.

3. U-fora.com claims to be the first social network to allow its users to upload and share their music and ebooks for other users and the public to download.

4. U-fora.com claims to be the first to offer its users its podcast, radio station and crowdfunding features whereas other platforms that offer podcast, radio station and crowdfunding features are not social networks.
